(19) United States
(12) Patent Application Publication
(10) Pub. No.: US 2024/0225018 A9
(43) Pub. Date: Jul. 11, 2024

(54) HAND HELD WIND-UP HIGH-POWERED SPRING NON-PENETRATING CAPTIVE BOLT DEVICE

(71) Applicant: M & J 5:15, LLC, Tipton, MO (US)

(72) Inventors: Jeffrey C. May, Lee's Summit, MO (US); Clay Blake, Fortuna, MO (US); Mark Koechner, Tipton, MO (US)

(73) Assignee: M & J 5:15, LLC, Tipton, MO (US)

(21) Appl. No.: 18/490,410

(22) Filed: Oct. 19, 2023

Related U.S. Application Data
(60) Provisional application No. 63/380,464, filed on Oct. 21, 2022.

(51) Int. Cl. A22B 3/02

(52) U.S. Cl. CPC A22B 3/02; A22B 3/08

(57) ABSTRACT

A non-penetrating captive bolt device includes a threaded mechanism for retracting a bolt against a biasing force. The bolt includes an elongated rod that projects rearward from the rear end of the bolt through a compression type spring that biases the bolt forward. A trigger actuated catch is mounted on the threaded mechanism with an internal bore, and the rod extends therein. When the threaded mechanism is advanced forward, the trigger actuated catch is advanced forward and engages the elongated rod. Retracting the threaded mechanism retracts the elongated rod and compresses the spring. Actuating triggers on the trigger actuated catch releases the elongated rod and the spring biases the bolt to a forward position.

### CROSS-REFERENCE TO RELATED APPLICATIONS

This application claims the benefit of U.S. Provisional Patent Application No. 63/380,464 filed Oct. 21, 2022, the disclosure of which is incorporated by reference herein.

### BACKGROUND OF THE INVENTION

### Field of the Invention

This invention relates to non-penetrating captive bolt devices.

### Description of the Related Art

Known prior art devices use a cartridge, compressed air, and/or compression springs to power non-penetrating or skull penetrating bolts for effecting concussive stunning or euthanasia of animals. U.S. Pat. No. 8,932,117 to Keck et al. discloses an apparatus for euthanizing poultry by rapidly impacting the spinal column of a bird with a forked rod using the stored energy of a helical compression spring. U.S. Pat. No. 1,668,432 to Thorstenson discloses a firearm having a rod extending from a cap member and a compressed spring attached between the cap member and a sleeve. Compression of the spring causes the rod to release a firing pin rod that impacts a cartridge. U.S. Pat. No. 863,909 to Evans discloses a centerer used for marking the centers of shafts having a compressed spring that functions to drive a marker. Swiss Patent No. CH170074A to Edelmann and German Publication No. 8,425,402 both disclose compression springs with firing triggers which engage a notch or groove on firing pins.

### SUMMARY OF THE INVENTION

A non-penetrating captive bolt device having a relatively large spring with a large spring force utilizes the mechanical advantage of a threaded mechanism for retracting a bolt against a biasing force of the spring. The device includes a housing formed from generally hollow, separate front and rear sections that rotate relative to each other. At least one annular bearing is fixedly secured within the rear end of the front housing section to assist such relative rotation. A bolt outlet opening is formed in a proximal end or front of the front housing section and a cylindrical passageway extends through the annular bearing between the housing sections.

The bolt includes a radially outward projecting flange on a rear end thereof and an elongated rod or stem projects rearward from the rear end of the bolt. A circumferential groove or notch is formed in a distal end of the elongated rod. A trigger actuated catch or trigger mechanism, including a catch and triggers, is fixedly mounted on the rear end of a hollow externally threaded cylinder within the rear housing section. The elongated stem extends through an internal bore in the externally threaded cylinder. The external threads on the externally threaded cylinder are threadingly coupled to internal threads of a housing coupler located adjacent the annular bearing.

A compression type coil spring is mounted within the front housing section with opposite ends captured between a front face of the annular bearing and a rear face of the flange formed on the rear end of the bolt. The spring normally biases the bolt forward such that, when the stem is released from the trigger actuated catch, a front portion of the bolt extends through the bolt outlet opening.

To retract the bolt and load the spring, the rear housing section is rotated in a first direction to advance the threaded cylinder and attached trigger actuated catch forward until the trigger actuated catch is advanced into alignment with and engages the circumferential groove on the distal end of the elongated stem. The rear housing section is then rotated in the opposite or second direction to retract the threaded cylinder and the trigger actuated catch engaging the stem rearward to draw the flanged bolt rearward against the biasing force of the spring. The rear housing section is rotated in the second direction until the trigger actuated catch is fully retracted relative to the rear housing section and the spring is compressed or loaded. When the trigger actuated catch is fully retracted, the bolt is fully retracted rearward past the bolt outlet opening and within the front housing section.

Longitudinally extending slots are formed in the rear housing section to allow the triggers of the trigger actuated catch to advance forward and rearward relative thereto. A circumferential recess is formed in a rear portion of the rear housing section to allow a user to access and actuate the triggers to release the elongated rod allowing the spring to rapidly advance the bolt forward through the bolt outlet opening at the front of the front housing section.

### DESCRIPTION OF THE DRAWINGS

Illustrative embodiments are described in detail below with the reference to the attached drawing figures, wherein:

FIG. 1 is a perspective view of a spring driven captive bolt device that has been fired, with a bolt in a forward or discharged position and a trigger actuated catch in the actuated position;

FIG. 2 is a cross-sectional view of the captive bolt device that has been fired taken along line 2-2 of FIG. 1;

FIG. 3 is a cross-sectional view similar to FIG. 2 showing the bolt in the forward position as in FIG. 2 but with the trigger actuated catch advanced toward a forward position just prior to the trigger actuated catch latching onto a notched stem of the bolt;

FIG. 4 is a cross-sectional view similar to FIG. 2 showing the bolt and the trigger actuated catch in the retracted position;

FIG. 5 is a cross-sectional view of the captive bolt device in FIG. 1;

FIG. 6 is a perspective view of the rear section broken away from the captive bolt device in FIG. 4, with a rear housing section removed and an end cap removed; and

FIG. 7 is a cross-sectional view of FIG. 6.

The drawing figures do not limit the invention to the specific embodiments disclosed and described herein. The drawings are not necessarily to scale, emphasis instead being placed upon clearly illustrating the principles of the invention.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

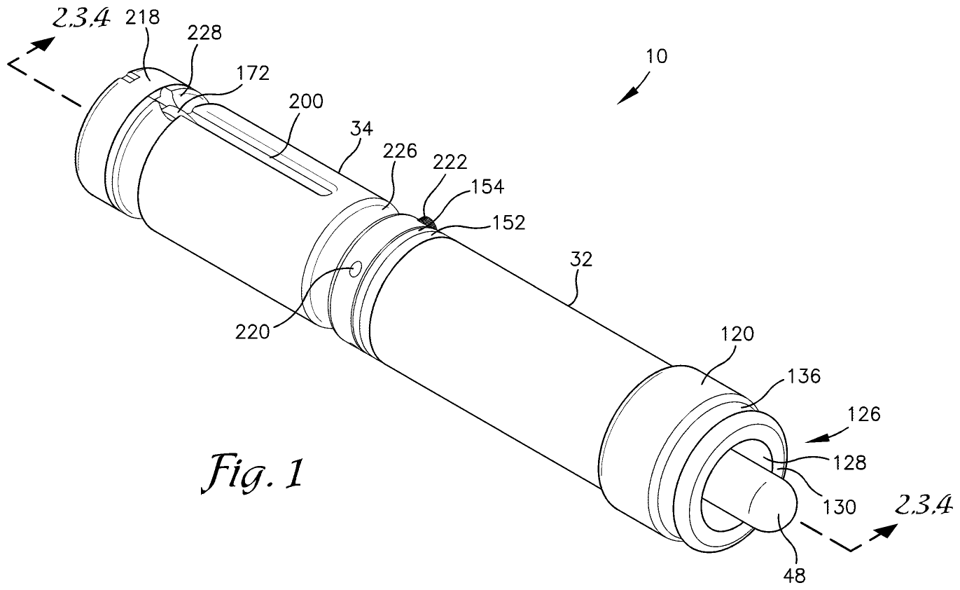

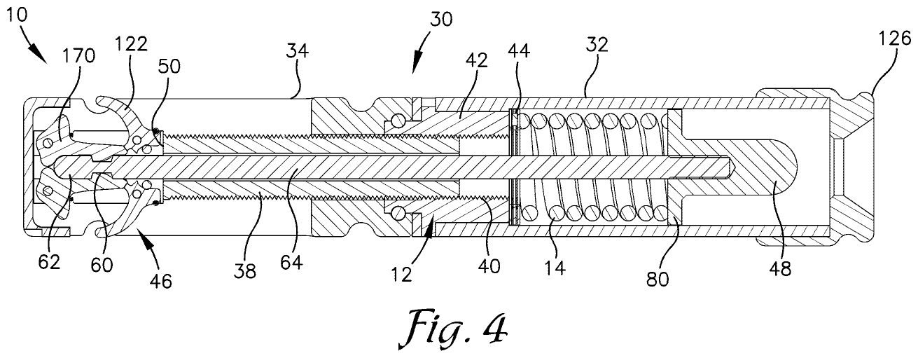

With reference to FIGS. 1-4, a handheld, wind-up, non-penetrating captive bolt device 10 includes a threaded action or threaded assembly 12 for loading or compressing a compression spring 14 acting on and selectively driving and discharging a flanged bolt 48 which is housed within a substantially cylindrical housing 30 having a front housing section 32 and a rear housing section 34 that rotate relative to each other to operate the threaded action 12. The threaded action 12 includes an externally threaded cylinder 38 within the rear housing section 34 that threadingly couples to an internally threaded portion 40 of the rear housing section 34 and/or of a housing coupler 42 located adjacent an annular bearing 44. The internally threaded portion 40 may be integral with the rear housing section 34. A trigger actuated catch 46 is fixedly mounted on a rear end 50 of the externally threaded cylinder 38. The trigger actuated catch 46 is first advanced to engage a bolt 48 by rotating the rear housing section 34 in a first direction. As the trigger actuated catch 46 is advanced forward by threading the externally threaded cylinder 38 in a first direction relative to the internally threaded portion 40, the trigger actuated catch 46 engages or latches onto a circumferential groove or notch 60 on an elongated rod or stem 64 extending rearward from the bolt 48. The trigger actuated catch 46 is then drawn rearward by rotating the rear housing section 34 in a second direction to retract the bolt 48 in engagement with the trigger actuated catch 46 against a biasing force of the compression spring 14, which in the embodiment shown is a coil spring. FIG. 4 shows the elongated stem 64 fully retracted in the retracted position. The threaded action 12 allows a compression spring 14 with a large spring force to be compressed by hand in the captive bolt device 10.

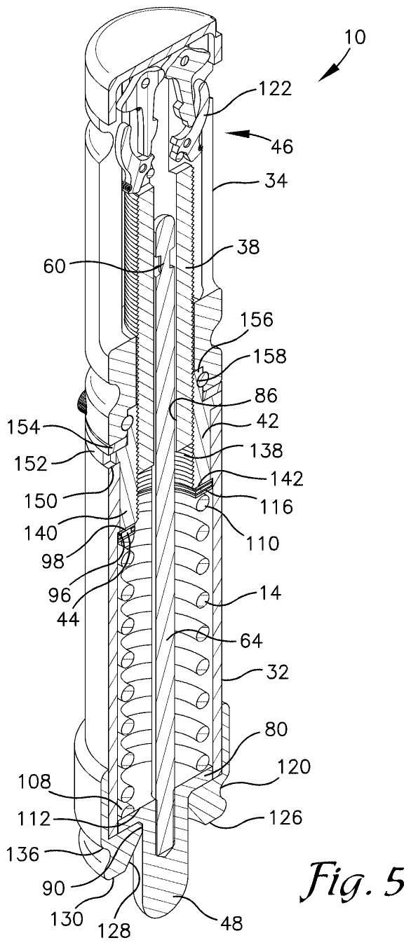

Referring to FIG. 5, the bolt 48 includes a radially outward projecting flange 80 on a rear end thereof and the elongated stem 64 projecting rearward from the rear end of the bolt 48. The bolt 48 is located in the front housing section 32 adjacent a bolt opening 90 formed at a proximal end of the front housing section 32. The circumferential groove 60 is formed on a distal end of the rearwardly extending elongated stem 64. The elongated stem 64 extends from the bolt 48 through the compression spring 14 in the front housing section 32, through a cylindrical passageway extending through the annular bearing 44 and housing coupler 42 between the housing sections, and through an internal bore 86 of the externally threaded cylinder 38 in the rear housing section 34.

The compression spring 14 is captured within the front housing section 32 between the flange 80 projecting outward from the rear of bolt 48 and the annular bearing 44. A forward-facing shoulder 96 may be formed circumferentially about an interior wall of the front housing section 32 against which the annular bearing 44 may be positioned. A rear face 98 of the annular bearing 44 abuts the shoulder 96 to prevent the annular bearing 44 from moving longitudinally in the front housing section 32. The compression spring 14 presses the annular bearing 44 against the shoulder 96. A first end 108 and a second end 110 of the compression spring 14 are captured by a rear face 112 of the flange and a front face 116 of the annular bearing 44, respectively.

The front housing section 32 and the rear housing section 34 enclose components of the captive bolt device 10, including the bolt 48, the elongated stem 64 that extends through the compression spring 14, the compressions spring 14 and the trigger actuated catch 46. The compression spring 14 biases the bolt 48 toward a forward or discharged position. The bolt 48, when driven to the discharged position, partially extends through the bolt opening 90 in a front cap 120. The front cap 120 may be configured to be secured to the front housing section 32 through one or more engagement features (not shown) that can withstand the force of the bolt 48 when discharged through the engagement of triggers 122 extending from the trigger actuated catch 46 to advance the trigger actuated catch 46 out of engagement with the circumferential groove 60 in stem 64 to release the elongated stem 64. The engagement features may include one or more of threads, frictional engagement components such as O-rings or gaskets, or other known engagement features.

The front cap 120 is cylindrically shaped with the bolt opening 90 extending through a center of a concave cap top 126. In the embodiment shown, the bolt opening 90 has a radial dimension that is slightly larger than the radial dimension of the bolt 48. The concave cap top 126 has a concave face 128 and a shoulder 130 that may be formed to fit the skull of an animal that is the subject of stunning or euthanasia. The front cap 120 may have a circumferential indentation 136 on an exterior wall for use by the user to grasp the front cap 120. In the embodiment shown, the captive bolt device 10 includes the housing coupler 42 with the internally threaded portion 40 that extends between the rear housing section 34 and the front housing section 32. The housing coupler 42 may be located within and/or between the front housing section 32 and the rear housing section 34. In one embodiment the internally threaded portion 40 of the housing coupler 42 extends within the forward end of the rear housing section 34 and within the rear end of the front housing section 32. The internally threaded portion 40 includes at least one thread for engaging the externally threaded cylinder 38. In a preferred embodiment the internally threaded portion 40 includes and is formed around a generally hollow, longitudinally extending cylindrical space 138 that extends between the rear housing section 34 and the front housing section 32. Threads of the internally threaded portion 40 project inward and mate with the threads of the externally threaded cylinder 38. The annular bearing 44 is disposed on a front face 142 of a housing coupler wall 140 of the housing coupler 42. In one embodiment, the front face 142 of the housing coupler wall 140 aligns with the shoulder 96 of the interior wall of the front housing section 32, and the annular bearing 44 is disposed on the front face 142 of the housing coupler wall 140 and the shoulder 96 of front housing section 32.

As shown in the figures, at a rear end 150 of the front housing section 32, a housing shoulder 152 is formed on and extends radially outward from the housing coupler wall 140. The rear end 150 of the front housing section 32 is disposed against a front face of the housing shoulder 152. A coupling washer 154 is disposed on the opposite side of the housing shoulder 152 than the front housing section 32, between the housing shoulder 152 and the rear housing section 34. The externally threaded cylinder 38 extends into a rear end 156 of the housing coupler 42. The rear end 156 of the housing coupler 42 extends from and is formed on the housing shoulder 152. In one embodiment the rear end 156 has an external radial dimension that is less than the external radial dimension of the housing shoulder 152 and of the housing coupler wall 140. A circumferential indentation 158 may circumscribe the rear end 156 of the housing coupler 42.

The externally threaded cylinder 38 in the rear housing section 34 includes the internal bore 86 through which the elongated stem 64 extends and is retracted and actuated or discharged. In the preferred embodiment, the internal bore 86 extends through the externally threaded cylinder 38, and between catch mounting members 160 projecting beyond a rear end 50 of the externally threaded cylinder 38. The catch mounting members 160 form an open slot 166 extending on opposite sides of and through the internal bore 86 on the rear end 50 of the externally threaded cylinder 38.

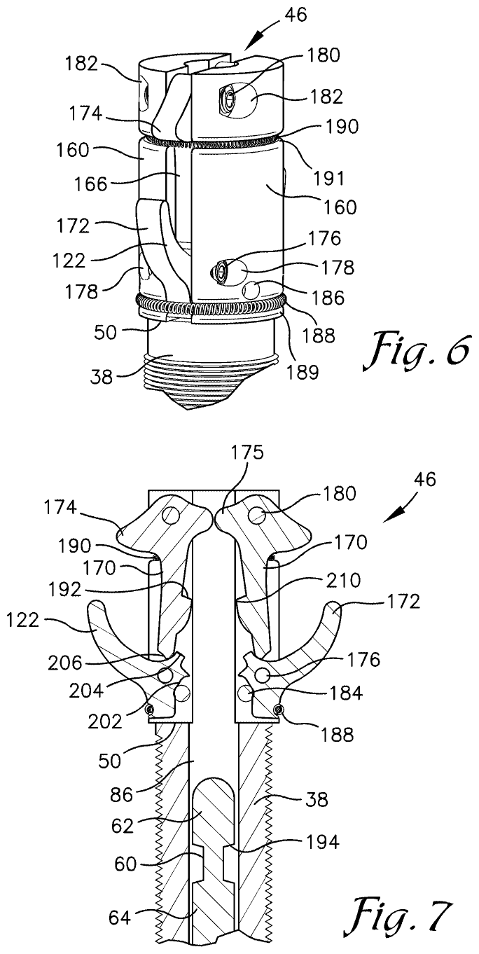

As show in FIGS. 6 and 7, the trigger actuated catch 46 is mounted to the catch mounting members 160 on the rear end 50 of the externally threaded cylinder 38 and in the open slot 166. The catch mounting members 160 are configured to accommodate the trigger actuated catch 46 in the open slot 166 extending therebetween. The trigger actuated catch 46 includes left and right triggers 122 and left and right latch arms 170. Each left and right trigger 122 is rotatably secured to the catch mounting members 160 by a trigger pivot pin 176 that extends through trigger apertures 178 formed in the catch mounting members 160. Each left and right trigger 122 engages the respective left and right latch arm 170 which are also rotatably secured to the catch mounting members 160.

Each trigger 122 includes an outwardly projecting trigger finger 172 that may be actuated by a user, a latch engaging sear or portion or finger 204 that selectively engages the respective latch arm 170, and a pin engaging portion 202 which assists in retaining the trigger 122 in desired positions.

The trigger fingers 172 of the triggers 122 extend outwardly through the open slot 166. When the trigger actuated catch 46 is in the latched and retracted position relative to the elongated stem 64, the trigger fingers 172 are biased in an outward position by a first biasing spring 188 and also extend through the longitudinal slots 200 of the rear housing section 34 as shown in FIG. 1. The first biasing spring 188 is seated within a first biasing spring indent 189 and encircles the base of the catch mounting members 160, engaging with and biasing the trigger fingers 172 in the open slot 166, such that the trigger fingers 172 extend outwardly through longitudinal slots 200 in the rear housing section 34. In the latched and retracted position, compressing or actuating the trigger fingers 172 rotates the triggers 122 about the trigger pivot pins 176 which releases the latch arms 170 and effects discharge of the bolt 48. The trigger fingers 172 may also assist in providing a driving mechanism for threading the trigger actuated catch 46 by extending through the open slot 166 and/or the longitudinal slots 200 as the externally threaded cylinder 38 is advanced or retracted within the internally threaded portion 40.

The pin engaging portions 202 control the rotation of the triggers 122 when the trigger fingers are compressed. Each pin engaging portion 202 of the triggers 122 is formed to engage the respective cylindrical left and right locating pin 184 that extends perpendicular to the captive bolt device 10 through a respective left and right aperture 186 located in the catch mounting members 160. The pin engaging portions 202 shown include an irregular concave surface with a slight bump or projection in the middle forming two pin receiving recesses or detents on each side thereof. When the first biasing spring 188 biasingly pivots the triggers 122, the latch engaging fingers 204 of the triggers 122 engage and retain the latch arms 170 in a latching position or ready-to-fire state relative to the elongated stem 64 of bolt 48, and the locating pins 184 extend into first pin receiving recesses of the pin engaging portions 202. When the trigger fingers 172 are actuated by compressedly pivoting the trigger fingers 172 inward, the trigger fingers 172 rotate about the trigger pivot pins 176 and the pin engaging portions 202 move about the circumference of the locating pins 184 until the locating pins 184 are seated in a second recess of the pin engaging portions 202 and the latch engaging fingers 204 of the triggers 122 release the latch arms 170.

The latch engaging finger 204 of each trigger 122 is formed as a projecting finger or sear and may have a slightly rounded or convex tip. Each latch engaging finger 204 is configured to be pivoted into engagement with a trigger engaging finger 206 formed on the end of each latch arm 170 when the latch arms 170 and the triggers 122 are pivoted to the latched position. The latch engaging fingers 204 hold the latch arms 170 in position, under tension of the compression spring 14, until the trigger fingers 172 are compressed with a required amount of pressure and the latch engaging fingers 204 move away from the latch arms 170, releasing the latch arms 170 which releases the bolt 48.

The latch arms 170 are rotatably secured to the catch mounting members 160, rearward of the triggers 122, by latch pivot pins 180 that extend through latch pivot pin apertures 182 in the catch mounting members 160. A second biasing spring 190 encircles the catch mounting members 160 and is located in a second biasing spring indent 191 that is forward of the latch pivot pins 180. The second biasing spring engages the latch arms 170 in the open slot 166 and may be used to bias the latch arms 170 to pivot about the pivot pins 180 toward the latching position. The second biasing spring 190 preferably has a weaker spring force than the first biasing spring 188. It is foreseen that the second biasing spring 190 may be located rearward of the latch pivot pins 180.

Each latch arm 170 includes an outwardly projecting latch arm lobe 174 that may assist in providing a driving mechanism for threadingly advancing or retracting the trigger actuated catch 46, an inwardly projecting latch arm lobe 175 engageable to assist in moving the corresponding latch arm 170 into the latching position, a trigger engaging portion or finger 206 selectively engageable by the respective trigger 122, and a notch engaging barb or portion 210 that may engage the circumferential groove or notch 60 on the elongated stem 64.

The outwardly projecting latch arm lobes 174 extend outward from a respective latch arm 170 through the respective left and right sides of the open slot 166. The outwardly projecting latch arm lobes 174, along with the trigger fingers 172, provide part of the driving mechanism for threadingly advancing and retracting the externally threaded cylinder 38 within the internally threaded portion 40. The outwardly projecting latch arm lobes 174 are formed on and are a part of the inwardly projecting latch arm lobes 175 that extend into the internal bore 86 between the catch mounting members 160. Engagement of the inwardly projecting latch arm lobes 175 by the head 62 of the elongated stem 64 causes the latch arms 170 to rotate about the latch pivot pins 180 and into the latching position.

When the head 62 of the elongated stem 64 engages the inwardly projecting latch arm lobes 175 causing the latch arms 170 to rotate inward and into a latched position with the circumferential groove 60 of the elongated stem 64, the trigger engaging fingers 206 of each latch arm 170 rotate inward and engage the latch engaging fingers 204 of the triggers 122 that are biased outward by the first biasing spring 188. The trigger engaging fingers 206 extend toward and are formed to engage the latch engaging fingers 204 of the triggers 122 and may include a slightly concave surface for mating with the latch engaging fingers 204. When engaged, the latch engaging fingers 204 maintain the trigger engaging fingers 206 and the respective latch arms 170 in a latched position.

The latch arms 170 engage the circumferential groove 60 of the elongated stem 64 by rotating inward about the latch pivot pins 180 such that the notch engaging barbs 210 on the inner faces of the latch arms 170 extend inward to engage the circumferential groove 60. The notch engaging barbs 210, as well as the latch engaging fingers 204 and the pin engaging portions 202 of the triggers 122, assist in maintaining the latch arms 170 in the latched position. The rear surfaces 192 of the notch engaging barbs 210 slope inwardly and forwardly cooperating with the outward and rearward sloping forward facing shoulder surface 194 of the head 62 of the elongated stem 64. Upon compression of the trigger fingers 172, the sloping surfaces 192, 194 allow the head 62 to be released and the forward biasing force of the compressed spring 14 advances the bolt 48 into the forward position.

As shown in FIGS. 3 and 7, the trigger engaging finger 206 of each latch arm 170 is pivoted outward relative to the latch engaging finger 204 and the bolt 48 is in a forward or discharged position. To load the bolt 48 against the biasing force of the compression spring 14, the trigger actuated catch 46 is advanced forward via the threaded action 12 until the head 62 of the stem 64 is advanced past the notch engaging barbs 210 and the head 62 engages the inwardly projecting lobes 175 pivoting the lobes 175 rearward. Rearward pivoting of the inwardly projecting lobes 175 pivots the latch arms 170 inward until the notch engaging barbs 210 are advanced into a latched position in which the barbs 210 extend into the circumferential groove 60 of the elongated stem 64 and the latch engaging finger 204 of each trigger 122 is biased by a first biasing spring 188 to move into abutment against a trigger engaging finger 206 of an aligned latch arm 170 to hold the latch arm 170 in a latched position. Preferably both latch arms 170 are latched in engagement with the circumferential groove 60 on the elongated stem 64. In the latched position, the trigger fingers 172 are biased outward and extend through the corresponding side of the open slot 166 and longitudinal slot 200 of the rear housing section 34. When the triggers 122 are compressed from the latched and retracted position, the latch engaging fingers 204 of the triggers 122 move inward or slide past the trigger engaging fingers 206 of the latch arms 170 to release the latch arms 170. The latch arms 170 rotate outward and the sloping surfaces 192, 194 cooperate to allow the notch engaging barbs 210 to advance out of the circumferential groove 60 of the elongated stem 64. In a preferred embodiment, both triggers 122 must be compressed to release the elongated stem 64.

With reference to FIG. 1, the cylindrical front housing section 32 extends between the front cap 120 and the housing shoulder 152 formed on the housing coupler 42. The rear housing section 34 extends between the coupling washer 154 and an end cap 218. The rear housing section 34 includes shoulder screw apertures 220 for shoulder screws 222 that secure a forward end of the rear housing section 34. In an embodiment, the circumferential indentation 158 that circumscribes the rear end 156 of the housing coupler 42 allows the shoulder screws 222 to rotate about the housing coupler 42 when the front housing section 32 and the rear housing section 34 are rotated relative to each other. The rear housing section 34 also includes a middle circumferential indentation 226 and a rear circumferential indentation 228. The longitudinal slots 200 extend longitudinally along opposite sides of the rear housing section 34 aligned with the trigger fingers 172 of the triggers 122 and intersect the rear circumferential indentation 228. A user may compress the trigger fingers 172 within the rear circumferential indentation 228 to discharge the bolt 48.

The end cap 218 is secured to the end of the rear housing section 34 in covering relationship with the end of the rear housing section 34 including the top of the catch mounting members 160, the open slot 166 and the top of the trigger actuated catch 46.

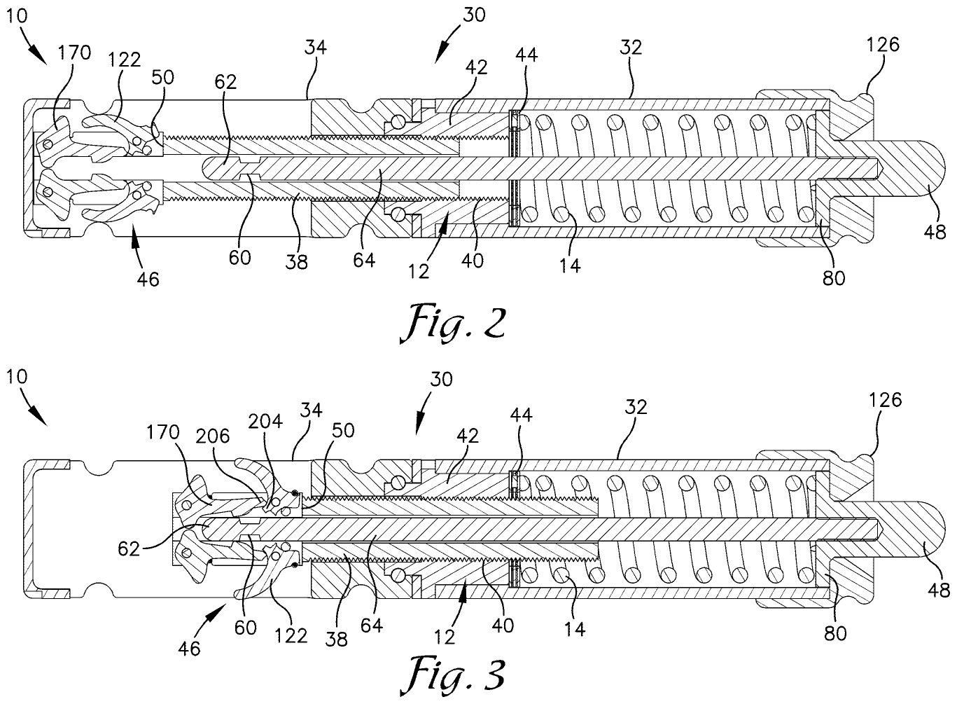

With reference to FIGS. 2-4, the method of use of the captive bolt device 10 is described in accordance with an exemplary embodiment. To retract the bolt 48 and load the compression spring 14, the rear housing section 34 is rotated in a first direction to advance the externally threaded cylinder 38 and attached trigger actuated catch 46 forward until the trigger actuated catch 46 is advanced into alignment with and engages the circumferential groove 60 in the elongated stem 64. The rear housing section 34 is then rotated in the opposite or second direction to retract the externally threaded cylinder 38 and the trigger actuated catch 46 engaging the elongated stem 64 rearward to draw the bolt 48 rearward against the biasing force of the compression spring 14. The trigger fingers 172 and the outwardly projecting latch arm lobes 174 project or extend through the open slot 166 when the externally threaded cylinder 38 is advanced and subsequently retracted within the internally threaded portion 40. The rear housing section 34 is rotated in the second direction until the trigger actuated catch 46 is fully retracted relative to the rear housing section 34 and the compression spring 14 is compressed or loaded rearward, rearward of the flange 80 on the bolt 48. When the trigger actuated catch 46 is fully retracted, the trigger fingers 172 extend through the longitudinal slots 200 and the bolt 48 is fully retracted rearward past the bolt opening 90 and within the front housing section 32. To release the elongated stem 64 of the bolt 48, the user compresses the left and right trigger fingers 172 extending from the longitudinal slots 200 at the rear circumferential indentation 228, simultaneously or sequentially. The elongated stem 64 is released from the trigger actuated catch 46, and the compression spring 14 biases the bolt 48 to advance forward rapidly such that a front portion of the bolt 48 extends through the bolt opening 90. In a preferred embodiment the bolt velocity is sufficient to effect concussive stunning and/or euthanasia of an identified type of animal, such bolt velocity being known to one skilled in the art. In one embodiment, the bolt velocity to euthanize poultry is greater than at least about 33 m/s.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

1. A captive bolt device, comprising:
a spring;
a bolt biased into a forward position by the spring, wherein the bolt has an elongated rod extending through the spring; and
a trigger actuated catch positioned rearward of the spring and engageable with the elongated rod, wherein
the trigger actuated catch is forwardly advanceable to engage the elongated rod and rearwardly retractable to draw the elongated rod rearward.

2. The captive bolt device of claim 1, further comprising a rear housing section that is rotatable relative to a front housing section, wherein rotating the rear housing section in a first directions advances the trigger actuated catch forward for engagement of the elongated rod and rotating the rear housing section in a second direction retracts the trigger actuated catch and the elongated rod to compress the spring rearward.

3. The captive bolt device of claim 2, wherein the trigger actuated catch includes at least one trigger finger that extends through at least one longitudinal slot in the rear housing section.

4. The captive bolt device of claim 1, wherein the trigger actuated catch includes two triggers, and the elongated rod is releasable by actuation of the two triggers.

5. The captive bolt device of claim 1, wherein the trigger actuated catch includes at least one notch engaging portion for engaging a notch in the elongated rod.

6. The captive bolt device of claim 1, wherein the trigger actuated catch includes a latch arm and a trigger, the latch arm is rotatable to engage the elongated rod, and the trigger is actuatable to release the elongated rod.

7. A captive bolt device, comprising:
a threaded action with an internal bore;
a spring captured between a bolt and the threaded action;
the bolt having an elongated rod extending through the spring and through the internal bore of the threaded action;
a trigger actuated catch mounted on the threaded action, and
a rear housing section rotatable relative to a front housing section, wherein
the threaded action includes an externally threaded cylinder that threadingly couples to an internally threaded portion of the rear housing section, and
the trigger actuated catch is engageable with the elongated rod to compress the spring rearward.

8. The captive bolt device of claim 7, wherein rotating the rear housing section in a first directions advances the trigger actuated catch forward to engage the elongated rod and rotating the rear housing section in a second direction retracts the trigger actuated catch and the elongated rod to compress the spring rearward.

9. The captive bolt device of claim 7, wherein the trigger actuated catch includes at least one trigger finger that extends through at least one longitudinal slot in the rear housing section.

10. The captive bolt device of claim 7, wherein the trigger actuated catch includes two triggers, and the elongated rod is releasable by actuation of the two triggers.

11. The captive bolt device of claim 7, wherein the trigger actuated catch includes at least one notch engaging portion for engaging a notch in the elongated rod.

12. The captive bolt device of claim 7, wherein the trigger actuated catch includes a latch arm and a trigger, the latch arm is rotatable to engage the elongated rod, and the trigger is actuatable to release the elongated rod.

13. The captive bolt device of claim 7, wherein the trigger actuated catch is mounted on the externally threaded cylinder of the threaded action.

14. A captive bolt device, comprising:
a threaded action with an internal bore
a spring captured between a bolt and the threaded action;
the bolt having an elongated rod extending through the spring and through the internal bore of the threaded action, and
a rear housing section rotatable relative to a front housing section, wherein
the threaded action includes an externally threaded cylinder that threading couples with an internally threaded portion of the rear housing section,
the externally threaded cylinder is forwardly advanceable for engagement of the elongated rod by rotating the rear housing section in a first direction relative to the front housing section, and the spring is rearwardly compressible by rotating the rear housing section in a second direction relative to the front housing section.

15. The captive bolt device of claim 14, further comprising a trigger actuated catch mounted on the threaded action.

16. The captive bolt device of claim 15, wherein the trigger actuated catch includes at least one trigger finger that extends through at least one longitudinal slot in the rear housing section.

17. The captive bolt device of claim 15, wherein the trigger actuated catch includes two triggers, and the elongated rod is releasable by actuation of the two triggers.

18. The captive bolt device of claim 15, wherein the trigger actuated catch includes at least one notch engaging portion for engaging a notch in the elongated rod.

19. The captive bolt device of claim 15, wherein the trigger actuated catch includes a latch arm and a trigger, the latch arm is rotatable to engage the elongated rod, and the trigger is actuatable to release the elongated rod.

20. The captive bolt device of claim 15, wherein the trigger actuated catch is mounted on the externally threaded cylinder, and the trigger actuated catch is forwardly advanceable to engage the elongated rod and rearwardly retractable to draw the elongated rod rearward.
